(19) United States
(12) Patent Application Publication
(10) Pub. No.: US 2003/0039274 A1
(43) Pub. Date: Feb. 27, 2003

(54) Method and apparatus for tissue treatment and modification

(76) Inventors: Joseph Neev, Lake Forest, CA (US); Oleg Konoplev, Irvine, CA (US)

Correspondence Address: STRADLING YOCCA CARLSON & RAUTH, IP Department, 660 Newport Center Drive, Suite 1600, P.O. Box 7680, Newport Beach, CA, 92660-6441, US

(21) Appl. No.: 09/878,002

(22) Filed: Jun. 8, 2001

Related U.S. Application Data
(60) Provisional application No. 60/210,531, filed on Jun. 8, 2000.

(51) Int. Cl. H01S 3/11

(52) U.S. Cl. 372/10

(57) ABSTRACT

An apparatus and method for an efficient, passively Q-switched microlaser producing high peak power pulses of light of extremely short duration are disclosed. This microlaser utilizes Yb³⁺:YAG as the gain medium instead of conventionally used Nd³⁺:YAG or Nd³⁺:YVO₄ gain media The utilization of the Yb³⁺:YAG allows superior performance of high peak-power microlaser in many aspects with respect to conventionally used Nd³⁺:YAG as the gain media. The efficiency of the pump of said microlaser (the so called optical-to-optical efficiency) can be higher by factor of two to four, with respect to Nd:YAG based, provided all other output parameters such as pulsewidth, output peak power and spatial quality of the beam being equal. The improved efficiency allows reducing the cost and size of the whole microlaser system substantially. In addition to lowering the cost of the microlaser system by factor of two to three, the temperature stability of the proposed microchip laser improved by factor of 5, due to the wider absorption bandwidth of the Yb³⁺:YAG to those of Nd³⁺:YAG or Nd³⁺:YVO₄.

### CROSS-REFERENCE TO RELATED APPLICATION

This application claims priority from U.S. provisional patent application No. 60/210,531, filed Jun. 8, 2000, entitled, HIGH POWER MICROCHIP LASER BASED ON YB:YAG AS THE GAIN MEDIUM, which is assigned to the assignee of the present patent application and incorporated herein by reference.

### FIELD OF THE INVENTION

The present invention is directed to an apparatus and method for obtaining high-peak-power pulses of laser light of extremely short duration through the proper selection of components for a passively Q-switched microlaser with high optical-to-optical, and hence overall efficiency. The improvement in the efficiency allows further miniaturization of the microlaser and reduction of the total cost of the microlaser system.

### BACKGROUND OF THE INVENTION

This invention relates to the field of lasers. Many applications require the generation of extremely short, high-peak-power pulses of light from a laser. (For the purpose of this discussion, extremely short will refer to pulse duration of about 1 ns or less; high peak power will refer to peak powers of about 100 kW or greater.)

One of the most effective method for producing short pulses with peak powers in excess of 10 kHz and multi-tens of kHz repetition rate is through microlaser cavity design by utilizing either passive or active Q-switching. (See for Example U.S. Pat. Nos. 5,394,413, 5,495,494, 5,844,932) Picosecond Q-switched microlasers can produce output pulses as short as large mode-locked lasers, with peak powers as high as commercially available Q switched systems. The entire device can fit into a package of approximately the size of a standard diode-laser package with the possibility of battery-powered operation.

The passively Q-switched microlaser does not require switching electronics, thereby reducing the size and complexity of the total system, and improving the power efficiency. In addition, there is no need for interferometric control of cavity dimensions, simplifying production of the device and greatly relaxing the tolerances on the temperature control of the device during use. The result is a potentially less expensive, smaller, more robust, and more reliable Q-switched system with very efficient performance. With this combination of attributes, passively Q-switched picosecond microlasers are very attractive for a large range of applications including micro-machining, various bio-medial applications, high-precision ranging, robotic vision, automated production, environmental monitoring, ionization spectroscopy, and nonlinear frequency generation.

### SUMMARY OF THE INVENTION

The high and medium power microlaser devices reported by Zayhowski had a pulsewidth in the range of 0.3-2.2 ns and peak power in the range of 50-500 kW.¹ One of the main disadvantages of these devices is their low total electrical to optical efficiency. The low electrical-to-optical efficiency of the high-power microlaser devices based on Nd³⁺:YAG can be explained by the low optical to optical efficiency, ηₒₚₜ₋ₒₚₜ, i.e. the efficiency of transferring optical pump radiation (from laser diode pump) to high-peak power output pulse radiation. This efficiency is usually 5-10%. The low ηₒₚₜ₋ₒₚₜ is due to the low fractional absorption of the pump. The low fractional absorption for high peak power, short pulse duration microlaser can be explained by low absorption coefficient and short gain medium length. The gain medium length can be increased at the expense of the increased pulse duration. The increased pulse duration forces microlaser to lose its uniqueness and positions them in a row with conventional, commercially available Q-switched systems. The elongation of the length of microlaser resonator cavity from 0.5-1 mm to 5-10 mm results in the increase of pulse duration from 0.1-0.2 ns to 1-2 ns. This in turn causes the microlaser lose its uniqueness, because the pulse duration of few nanoseconds become comparable with that of emitted by conventional Q-switched system.

The low absorption coefficient of the pump is due to the low available consentration of Nd³⁺ ions in the YAG lattice. Higher concentration of Nd³⁺ in the YAG host is impossible due to deterioration of the optical quality of the YAG, making it non-useful laser material.

Laser System.

The apparatus of the invention comprises a gain medium and a saturable absorber disposed within a resonant cavity. The gain medium and saturable absorber are diffusion bonded to undoped pieces of YAG on outer edges. The outer boundaries of the undoped pieces of YAG constitute the resonator cavity. The special coatings are disposed onto these two undoped pieces. Two undoped pieces of YAG with typical thickness of 1 mm each are optional, but added to increase optical damage resistance threshold.

When appropriately pumped, an optical pulse begins to form in the microlaser resonator. During the early stages of the pulse development, the saturable absorber is bleached, increasing the quality, Q, of the resonator and resulting in a short optical pulse. The length of the cavity, the laser gain, the intracavity saturable loss, and the reflectivities of the mirrors are selected such that pulses of less than about 0.3-1 ns duration are efficiently generated with peak powers in excess of 100,000 times the pump power (for example, 200 kW for a 2 W pump).

Although the emission character of MCL is pulsed, it can be pumped and is pumped with continuous wave (CW) laser diode. Microchip laser contains two major components, laser hosts and saturable absorber, positioned at the immediate contact one with respect to another. MCL laser cavity is formed by the outer surfaces of laser host and saturable absorber, or, as in the case of presence of undoped pieces, by the outer surfaces of undoped pieces. Saturable absorber provides Q-switching. This type of Q-switching is called passive, because no external electric or mechanical force is applied. Short pulse length is achieved due to the shortness of the cavity. Typical cavity length is ˜1-5 mm.

Four major output beam parameters of the MCL are:

1. Energy of a single pulse . . . Eₚ

1. Pulse Duration of the individual pulse . . . τₚ

3. Repetition rate of the pulses . . . ƒᵣₑₚ

4. Spatial quality of the beam . . . M²

The first three parameters can be designed following simplified equations, derived from the rate equations of passively Q-switched lasers. The fourth parameter, the beam quality, which can be characterized by M² parameter, is the function of the material quality, coating quality, pump quality, thermal load.

The pulse energy can be estimated using the following Equation,²

$${E}_{p} = \frac{{hv}_{L}}{{σ}_{L}} {A}_{L} Δ R {η}_{out} \qquad ( 1 )$$

where hv_{L} is the photon energy, σ_{L} the emission cross section, A_{L} the beam areas inside the laser, ΔR the modulation depth of the saturable absorber, and ηₒᵤₜ the output coupling efficiency (ratio of output coupling and total nonsaturable losses l). The expression for the FWHM pulse width of the Q-switched pulses is,

$${τ}_{p} = \frac{3.52 \cdot {T}_{R}}{Δ R} \qquad ( 2 )$$

with T_{R} being the cavity round-trip time.

The pulse repetition rate is given by

$${f}_{rep} = \frac{{g}_{0} - ( 1 + Δ R )}{2 Δ R {τ}_{L}} \approx \frac{{g}_{0}}{2 Δ R {τ}_{L}} \qquad ( 3 )$$

where g₀ is the small signal gain, and τ_{L} the upper-state-level lifetime of the gain medium. The last part of equation 3 is valid far above threshold, where the threshold small signal gain l+ΔR can be neglected

With typical numbers

$$\frac{{hv}_{L}}{{σ}_{L}} = 1 J \text{/} {cm}^{2} ;$$

A_{L}=5×10⁻⁴ cm²; ΔR≈0.05; hₒᵤₜ≈0.2; Lᵣₑₛ≈1.5 mm; g₀≈0.2; τ_{L}≈200 μs; we get output laser parameters Eₚ≈5 μp; τ_{P}≈1.0 ns; fᵣₑₚ≈10 kHz, and average power Pₐᵥₑ≈50 mW.

To make higher energy per pulse output we have to choose material with higher saturation fluence

$${J}_{sat} \approx \frac{{hv}_{L}}{{σ}_{L}} ,$$

and pump higher area A_{L}. To reduce pulse duration we need to shorten resonator cavities Lᵣₑₛ, and to increase saturable absorber modulations ΔR.

The repetition rate is dependent primarily on one internal parameter of the laser, τ_{L}—upper level lifetime and one external parameter Pₚᵤₘₚ, power of the pump,

$${f}_{rep} ∝ \frac{{P}_{pump}}{{τ}_{L}} \qquad ( 4 )$$

Using Equations 1-3, one could predict, with ˜30% accuracy Eₚ, τₚ, fᵣₑₚ, of commercially available, OEM-available, and table top models published so far.

The major differences between utilizing Yb³⁺ and Nd³⁺ in microlaser system

The major differences between utilizing Yb³⁺ and Nd³⁺ in YAG laser host is that one can achieve higher absorption of the pump with Yb³⁺ than with Nd³⁺. This in turn increases the overall efficiency of the microlaser and allows miniaturization and reduction of the cost for the whole microlaser system. In addition the higher absorption coefficient allows the reduction of the whole cavity length and the generation of shorter in temporal duration pulses.

This work proposes to Use Yb:YAG instead of Nd³⁺:YAG in passively Q-switched microlaser as the laser hosts. The central emission wavelength of the Yb:YAG is different from that of Nd³⁺:YAG by 3%. This small change allows utilizing the same saturable absorbers in microlasers with Yb:YAG as gain medium as in microlasers with Nd:YAG as gain medium. Namely the Cr⁴⁺:YAG and LiF₂ can be used as passive Q-switchers.

Yb:YAG has many advantages over Nd³⁺:YAG when utilized in miniature, diode-pumped laser optical devices as the gain medium. Yb:YAG exhibits a complete set of properties favorable for high power diode pumping:³

Very low quantum defect (91% quantum efficiency).

Very low fractional heating (<11% )

Very high slope efficiency (77%@300K).

Broad absorption bands (≈10 nm@940 nm).

High doping level, possible without quenching (>20%).

No excited state absorption or up-conversion.

Pump wavelength 940 nm, enables the use of very reliable InGaAs diodes.

High thermal conductivity and tensile strength of the host material.

Properties of Yb:YAG of special interest for high-peak power, shot-pulsed radiation are:

Long radioactive lifetime of upper laser level (˜1 ms).

Broad emission bands (generation of pulses as short as 1 ps is possible).

Low emission cross-section (high energy can be stored).

The only severe disadvantage of Yb:YAG is the thermal population of the lower laser level (612 cm⁻¹ above the ground level), which leads to the requirements of high pump-power densities (threshold>1.5 kW/cm²@T=300K). This drawback can be circumvented by active cooling design.⁴

Efficient operation of Yb:YAG maybe achieved with pump power near ˜10 kW/cm²). Such values are only available with high-brightness laser diodes.

Comparison of properties of Nd³⁺:YAG and Yb³⁺:YAG are summarized in Table I.^{5,6}

TABLE I
Comparison of Laser Properties of Yb:YAG and Nd:YAG

| Material | Yb: YAG | Nd: YAG |
|---|---|---|
| τₗₐₛₑᵣ | 950 μs | 257 μs |
| σ_{pump, abs} | 7.6 × 10⁻²¹ cm⁻¹ | 1.5 × 10⁻¹⁹ cm² |
| I_{pump, sat} | 26.7 kW/cm² | 4.8 kW/cm² |
| σₗₐₛₑᵣ₍ₑₘᵢₛₛᵢₒₙ₎ | 3.3 × 10⁻²⁰ cm² | 2.6 kW/cm² |
| I_{laser, sat} | 6.1 kW/cm² | 2.6 kW/cm² |
| J_{laser, sat} | 5.8 J/cm² | 0.67 J/cm² |
| Quantum Defect | 8.6% | 24% |
| Pump Wavelength | 942 nm | 808 nm |
| Lasing Wavelength | 1030 nm | 1064 nm |
| Pump Linewidth | ˜15 nm | 3 nm |
| Lasing Linewidth | ˜5 nm | ˜0.5 nm |
| Fractional Heating | ˜11%** | ˜15% |
| Pump Diode | InGaAs | AlGaAs |

Yb:YAG as lasing material was experimentally demonstrated as MCL low power version 7 as up-scaled CW version in thin disk configuration, 3 and as Q-switched rod configuration as lasing media. 6 In MCL version, 500 ps, 1 μJ pulses were achieved at 12 kHz. With pump absorbed power 29 mW, the emitted average power was 13 mW. In thin disk configuration output powers of up to 346 W generated with efficiency electrical-to-optical efficiency 17%. In end-pumped rod configuration up to 340W out was generated. When electro-optical Q-switch was added, 90% of CW power was extracted, at repetition rate of 3-10 kHz. 6 The very lower difference between CW power and Q-switched powers with kiloHertz repetition rate can be attributed to long upper-state level lifetime.

The main point of utilizing Yb³⁺ instead of Nd³⁺ in the YAG matrix is that one can achieve the same laser output parameters out of microlaser system utilizing laser diode pump with factor of five less in output power. To compare output HP (high power) MCL characteristics made of Yb:YAG and Nd:YAG one can use Eq. 1-3.

This is summarized in the two examples below. The first example assumes that gain medium is Nd³⁺:YAG, the second Yb³⁼:YAG. In both example Pₚᵤₘₚ is the power of the pump, Eₚ is the output energy of the pulse, τₚ is the pulse duration, wₒ is the size of the waist of output beam, Pₚₑₐₖ, Jₚₑₐₖ, Iₚₑₐₖ are the output peak power, peak fluence and peak intensity, fᵣₑₚ is the pulse repetition rate, and P_{avg,out} is the output average power.

### EXAMPLE 1

### Microlaser Cavity Design Based on Nd³⁺:YAG/Cr⁴⁺:YAG

| | | | |
|---|---|---|---|
| Undoped | Nd³⁺:YAG | Cr⁴⁺:YAG | Undoped |
| YAG | (1-2 wt %) | T_{closed} = 40% | YAG |

←--------------------------------Resonator Cavity--------------------------------→

| | | | |
|---|---|---|---|
| 1 mm | L_{Nd} = 2-3 mm | 2-6 mm | 1 mm |

Pₚᵤₘₚ=10W; Eₚ=225 μJ; τₚ=700 ps; wₒ=90 μm; Pₚₑₐₖ=270 kW; Jₚₑₐₖ=1.8 Jcm²; Iₚₑₐₖ=2.2 GW/cm², fᵣₑₚ=2 kHz, P_{avg,out}≈0.4W

### EXAMPLE 2

### Microlaser Cavity Design Based on Yb³⁺:YAG/Cr⁴⁺:YAG.

| | | | |
|---|---|---|---|
| Undoped | Yb³⁺:YAG | Cr^{4 +}:YAG | Undoped |
| YAG | (10-20 wt %) | T_{closed} = 40% | YAG |

←--------------------------------Resonator Cavity--------------------------------→

| | | | |
|---|---|---|---|
| 1 mm | L_{Yb} = 2-3 mm | 2-6mm | 1 mm |

Pₚᵤₘₚ=2W; Eₚ=225 μJ; τₚ=700 ps; wₒ=90 μm;; Pₚₑₐₖ=270 kW; Jₚₑₐₖ=1.8 J/cm²; Iₚₑₐₖ=2.2 GW/cm², fᵣₑₚ=2 kHz, P_{avg,out}≈0.4W

### BRIEF DESCRIPTION OF THE DRAWINGS

The foregoing and other objects, features, and advantages of the invention will be apparent from the following more particular description of preferred embodiments of the invention, as illustrated in the accompanying drawings in which reference characters refer to the same parts throughout tile different views.

FIG. 1 is a perspective view of a passively Q-switched picosecond microlaser imbodying the present invention. For illustrative purposes, the microlaser system is separated into pump, the microlaser resonator cavity (microlaser itself), and into output radiation.

FIG. 2 Is the perspective view of the preferred embodiment of the present invention wherein a passively Q switched picosecond microlaser is pumped by the output of an optical fiber, and cavity endfaces are flat or convex. The laser output is frequency multiplied (doubled, tripled, quadrupled, and quintupled) through frequency harmonic generation or divided by virtue of using of optical parametric amplification.

FIG. 3 Is the perspective view of the preferred embodiment of the present invention wherein a passively Q switched picosecond microlaser is pumped directly by a laser diode or laser diode bar disposed in immediate contact with microlaser cavity. The laser output is frequency divided by virtue of utilizing of optical parametric amplification, using periodically poled structure. This embodiment is preferred due to matching to the geometrical configurations of commercially available diode bar and periodically poled crystals, such as LiNbO₃ and KTP.

### DETAILED DESCRIPTION OF PREFERRED EMBODIMENTS

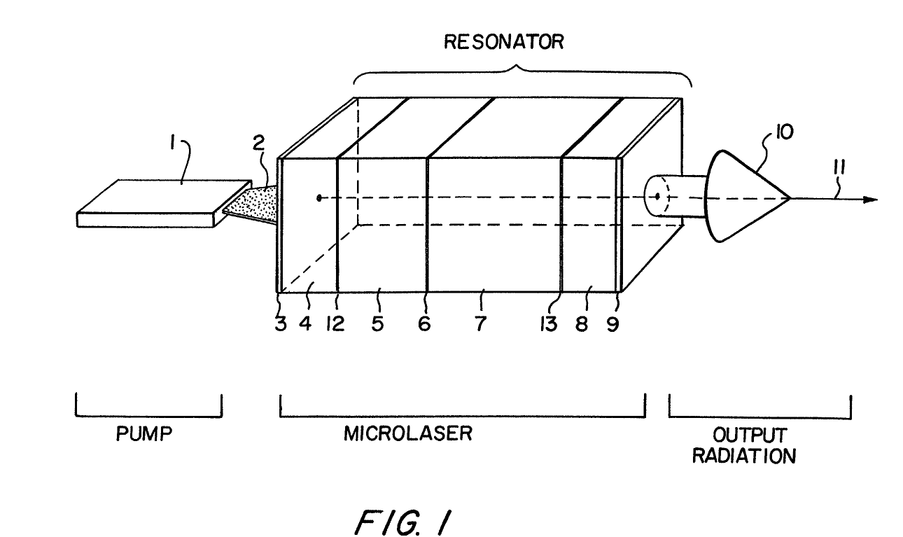

Referring to FIG. 1, one embodiment of the passively Q-switched picosecond microlaser comprises a short piece of gain medium 5, made of Yb³⁺:YAG, bonded through diffusion bonding 6 to a saturable-absorber crystal 7, made of Cr⁴⁺:YAG or LiF₂-saturable absorbers. Outer surfaces of both materials, the gain medium 5 and saturable absorber 7 are, in turn, diffusion bonded to undoped YAG pieces 4 and 8 through bonding 12 and 13. All four pieces: 4, 5, 7, 8 are polished flat and parallel on the faces normal to the optical axis 11.

The pump side face 3 of the undoped piece 4 is coated dielectrically to transmit the pump light 2 and to be highly reflecting at the oscillating frequency_{L}. The output face 9 of the undoped YAG piece is coated to be partially reflecting at the oscillating frequency (reflectivity R) and provides the optical output 10 from the device.

The principle behind the operation of the passively Q-switched microlaser is that tile saturable absorber 7 prevents the onset of lasing until the average inversion density within the cavity reaches certain threshold value. After the bleaching of saturable absorber 7, the energy stored in the gain medium 5 is released in one single pulse. After emission of the single pulse, saturable absorber is closed, and accumulation of energy in the gain medium 5 started again due to the continuously present pump 1.

The gain-medium-dependent factors include the maximum inversion density obtainable for the available pump power and the gain bandwidth. The microlaser cavity can be designed to obtain maximum peak power, maximum pulse energy, and minimum pulsewidth.⁸ This design can be achieved by varying gain medium active ion consentration (consentration of Yb³⁺ atoms) in gain medium matrix host (YAG), by varying the width of gain medium, width of saturable absorber, and reflectivity of output coupler (R). The width and consentration of gain medium is to be chosen so that to absorb pump effectively. The optical thickness (the thickness along optical axis 11) and consentration of saturable absorber 7 (consentration of Cr⁴⁺ atoms in YAG host) is to be chosen to provide optimal pulsed operation. The optimal reflectivity of the output coupler, R, in Nd:YAG microlaser, which provide the maximum peak power and shortest pulse duration should be approximately equal to the initial transmission of saturable absorber, T_{sa,closed}, R=T_{sa,closed}. In the Yb:YAG microlaser the large optical intensities that result from extremely short pulses and high saturation fluence Jₛₐₜ may damage the gain medium 5, saturable absorber 7, interface 6, undoped pieces 4 and 8, or dielectric coatings (mirrors) 3 and 9 much easier than in Nd:YAG microlaser. Due to this, depending on pump conditions, the optimum reflectivity of the output coupler 9 for maximum peak power should be chosen slightly below the initial transmission of the saturable absorber 7,

R≦T_{sa,closed} (5)

The typical initial saturable absorber transmission T_{sa,closed} and reflectivity of output coupler can be chosen 50% and 40% respectively, but can be as low as 20% and 20% for intensive pumping.

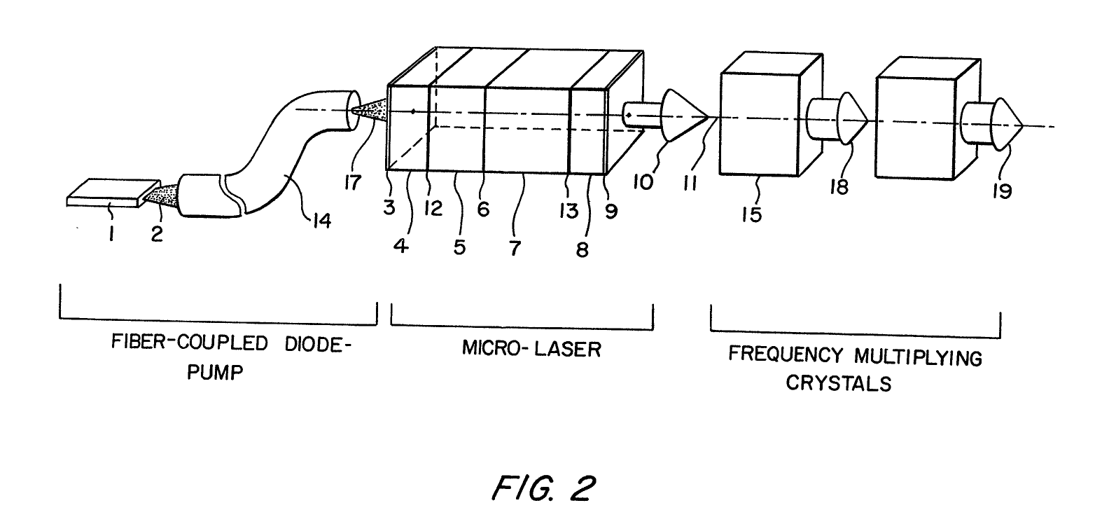

One preferred embodiment of the application of present invention is shown in FIG. 2. The output of the optical fiber 14 provides sufficient pump intensity 17 for the microlaser to reach (and exceed) threshold, without the need for focusing optics. A frequency-doubling crystal 15, for example KTP (KTiOPO₄), is disposed in the path of the laser output beam 10 for generating light 18 at the second harmonic of the oscillating frequency. For example, laser light at an infrared wavelength of 1030 nm, may be converted by the frequency-doubling crystal into green light at 515 nm.

Frequency-doubling crystals may be stacked for generating light at a frequency that is the fourth harmonic of the laser output 10. A second crystal 16, for example BBO (β-BaB₂O₄), is placed adjacent to the first frequency-doubling crystal 15. The laser output 19 is frequency doubled by the first frequency-doubling crystal 15. The output 18 of the first frequency-doubling crystal 15 passes through the second frequency-doubling crystal 16, and is transformed into light 19 at the fourth harmonic of the laser output 10. With this embodiment, diode light 2, transmitted over an optical fiber 14, may be converted by the passively Q-switched picosecond microlaser into laser light 19, which is subsequently quadrupled in frequency by the frequency-doubling crystals 15 and 16 into ultraviolet light 19, which could not be efficiently transmitted using currently available fibers. The, ultraviolet light 19 may be generated several kilometers away from a pump diode 1, at the opposite end of a fiber optic cable 14.

The saturable absorber material 7 and gain medium 5 may both be contained within a common material, as in the case of Yb³⁺, Cr⁴⁺:YAG. In another embodiment, the saturable absorber material 7 and gain medium 5 are two different crystals compromised of dopants in a common host, such as Yb³⁺:YAG and Cr⁴⁺:YAG (where YAG is the common host) and are diffusion-bonded, eliminating the need for an interface dielectric 6.

If a saturable-absorber material 7 is chosen which is non-absorbing of light at the pump frequency, then the placement of the gain medium 5 and saturable-absorber material 7 may be reversed so that the gain medium 5 is disposed adjacent to the output face 9 or undoped piece 8 and the saturable-absorber material is disposed adjacent to the pump-side face 3 or undoped piece 4.

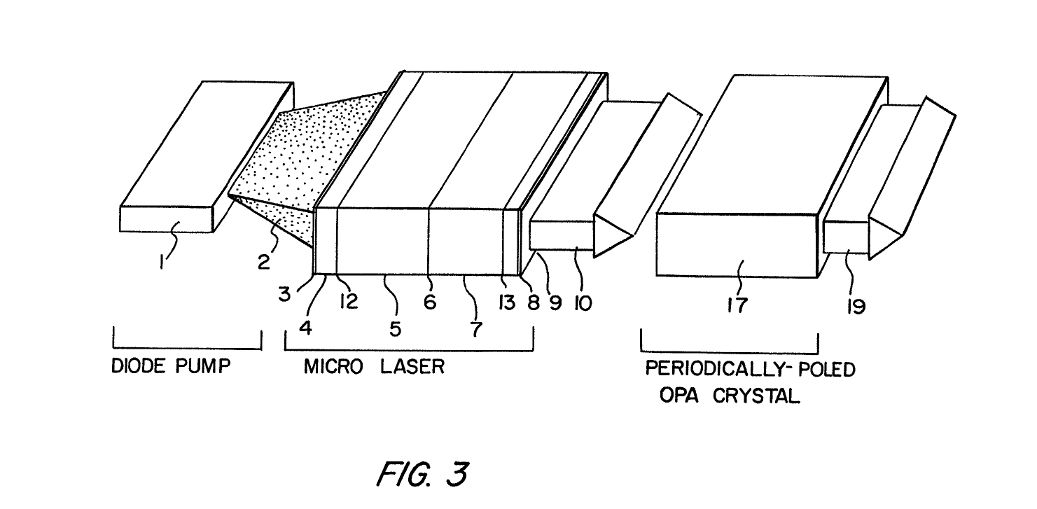

Another preferred embodiment of the microlaser is shown on FIG. 3. The laser diode bar with typical size of the bar of 10 mm is disposed in immediate contact with microlaser cavity. The microlaser cavity is also designed geometrically to be elongated in the direction of diode bar longest side. Each diode in the bar may produce enough radiation to form the separate microlaser cavity. The emission from microlaser can be upscaled in this design in terms of output power. Also this pattern of emission can be conveniently match and effectively coupled into frequency down-converting crystal. The frequency down-conversion can be realized by virtue of optical parametric amplification, by positioning for example, periodically poled LiNbO₃ or periodically-poled KTP crystal in immediate contact with respect to output 10 of microlaser. Multiwatt output powers with average pulse repetition rate equal to the pulse repetition rate out of individual microlaser cavity multiplied by the number of lasing cavities can be generated.

The extremely short pulses make the microlaser device attractive for many bio-medical application, including dentistry, delicate skin-treatments, skin resurfacing, cardiovascular revasculation, inner ear surgery and many others. Scientific, aeronautic, space applications may include high-precision optical ranging, robotic vision and automated production.

Additional Embodiments Include:

23. A passively Q-switched laser comprising:

a) a resonant cavity formed between a first mirror and a second mirror; said second mirror having a reflectivity R≦T_{sa,closed}, and T_{sa,closed} is the initial, unbleached transmission of said saturable absorber to the microlaser radiation light.

b) a gain medium disposed within said resonant cavity for producing laser gain;

c) a pump source for energizing said gain medium; and

d) a saturable absorber disposed within said resonant cavity; said saturable absorber preventing the onset of said pulses until the average inversion density within said resonant cavity reaches a certain threshold value.

24. A passively Q-switched laser for producing high-peak-power pulses of light comprising:

a) a resonant cavity formed between a first mirror and a second mirror;

b) a gain medium disposed within said resonant cavity for producing laser gain;

c) a pump source for energizing said gain medium; and

d) a saturable absorber disposed within said resonant cavity; said saturable absorber, said second mirror, and said laser gain being selected so that output pulses having a duration of less than about 1 nanosecond are generated; said gain medium and said saturable absorber being two separate materials comprised of dopants in a common host; said gain medium and said saturable absorber being bonded by diffusion bonding.

25. A passively Q-switched laser for producing high-peak-power pulses of light comprising:

a) a resonant cavity formed between a first mirror and a second mirror;

b) a gain medium disposed within said resonant cavity for producing laser gain;

c) a laser diode pump source for energizing said gain medium; and

d) a saturable absorber disposed within said resonant cavity; said saturable absorber, said second mirror, and said laser gain being selected so that output pulses having a peak power of greater than about 10,000 times said laser diode pump power are generated; said gain medium and said saturable absorber being two separate materials comprised of dopants in a common host; said gain medium and said saturable absorber being bonded by diffusion bonding.

26. A passively Q-switched laser for producing high-peak-power pulses of light, comprising:

a) a gain medium having opposed first and second faces for producing laser gain from light emitted by a pump source; said first face being highly transmissive to light emitted from said pump and being highly reflective to light at the lasing wavelength; and

b) a saturable absorber having opposed first and second faces; said first face of said saturable absorber being disposed adjacent said second face of said gain medium at an interface; said interface being highly transmissive of light at said lasing wavelength; said second face of said saturable absorber having a reflectivity R, where R is chosen close to initial saturable absorber transmission

27. A method of forming a passively Q-switched laser comprising the steps of:

a) forming a resonant cavity between a first mirror and a second mirror;

b) disposing a gain medium within said resonant cavity for producing laser gain;

c) energizing said gain medium with a pump source; and

d) disposing a saturable absorber within said resonant cavity; selecting said saturable absorber, said second mirror, and said laser gain so that output pulses having a duration of less than about 1 nanosecond are generated

28. The method of claim 27 wherein said second mirror is an output coupler having reflectivity R≦T_{sa,closed}, where T_{sa,closed} is the initial, unbleached transmission of said saturable absorber to the microlaser radiation light.

29. The method of claim 27 further comprising the step of diffusion bonding said gain medium and said saturable absorber wherein said gain medium and said saturable absorber are two separate materials comprised of dopants in a common host.

30. The method of claim 27 wherein said gain medium and said saturable absorber are the same crystal.

31. The method of claim 27 wherein said pump source comprises an optical fiber for transmitting pump light energy; said optical fiber being optically coupled to said first mirror for pumping said gain medium with said light energy.

32. The method of claim 27 further comprising the step of disposing nonlinear optical crystals in proximity with said second mirror for frequency conversion of said pulses emitted by said laser.

33. A method for forming a passively Q-switched laser comprising the steps of:

a) forming a resonant cavity between a first mirror and a second mirror;

b) disposing a gain medium within said resonant cavity for producing laser gain;

c) energizing said gain medium with a laser diode pump source; and

d) disposing a saturable absorber within said resonant cavity; selecting said saturable absorber, said second mirror, and said laser gain so that output pulses having a peak power greater than about 100 kilowatt are generated.

34. The method of claim 33 wherein said second mirror comprises an output coupler having reflectivity R,

35. A method for forming a passively Q-switched laser comprising the steps of:

a) forming a resonant cavity between a first mirror and a second mirror;

b) disposing a gain medium within said resonant cavity for producing laser gain;

c) energizing said gain medium with a laser-diode pump source; and

d) disposing a saturable absorber within said resonant cavity; selecting said saturable absorber, said second mirror, and said laser gain that output pulses having a peak power greater than about 10,000 times said laser-diode pump power are generated.

36. The method of claim 35 wherein said second mirror comprises an output coupler having reflectivity R, where R≦T_{sa,closed}, and T_{sa,closed} is the initial, unbleached transmission of said saturable absorber to the microlaser radiation light.

a) forming a gain medium having opposed first and second faces for producing laser gain from light emitted by a pump source; said first face being highly transmissive to light emitted from said pump and being highly reflective to the light at the lasing wavelength; and

b) disposing a saturable absorber having first and second faces adjacent to said gain medium; and one of the undoped pieces, said first face of said saturable absorber being disposed adjacent to said second face of said gain medium at an interface; said interface being highly reflective of light at said lasing wavelength; said second face of said saturable absorber having a reflectivity R R≦T_{sa,closed}, where T_{sa,closed} is the initial, unbleached transmission of said saturable absorber to the microlaser radiation light.

It will be understood by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

We claim:

1. A Q-switched microlaser comprising:
a) a resonant cavity formed between a first mirror and a second mirror;
b) a Yb³⁺:YAG medium disposed within said resonant cavity for producing laser gain;
c) a pump source for energizing said gain medium; and
d) a saturable absorber disposed within said resonant cavity; said saturable absorber, said second mirror, and said laser gain being selected so that output pulses having a duration of less than about 1 nanosecond are generated.
e) two undoped pieces diffusion bonded to outer surfaces of saturable absorber and gain medium

2. The laser of claim 1 wherein said second mirror is an output coupler having reflectivity R, R≦T_{sa,closed}, where T_{sa,closed} is the initial, unbleached transmission of said saturable absorber to the microlaser radiation light.

3. The laser of claim 1 wherein said gain medium and said saturable absorber are two separate materials comprised of dopants in a common host and wherein said gain medium and said saturable absorber are joined by diffusion bonding.

4. The laser of claim 3 wherein said gain medium is doped with Yb³⁺ and said saturable absorber is doped with Cr⁴⁺

5. The laser of claim 3 wherein said host material comprises of YAG.

6. The laser of claim 1 wherein said gain medium and said saturable absorber are the same crystal.

7. The laser of claim 1 wherein said gain medium is diffusion bonded on said saturable absorber.

8. The laser of claim 1, wherein the outer parts of the said laser are composed of undoped pieces of on which dielectric coatings are disposed

9. The laser of claim 1 wherein said pump source comprises an optical fiber for transmitting pump light energy; said optical fiber being optically coupled to said first mirror for pumping said gain medium with said light energy.

10. The laser of claim 9 wherein said optical coupling between said optical fiber and said first mirror is without intermediate focussing optics.

11. The laser of claim 1 wherein the outer parts of undoped YAG pieces of said microlaser are diffusion bonded on said gain medium and said saturable absorber

12. The laser of claim 1 wherein the coatings of said microlaser are applied on the undoped YAG pieces

13. The laser of claim 1 wherein said resonant cavity is less than 10 mm length.

14. The laser of claim 1 wherein said gain medium comprises a solid-state material.

15. The laser of claim 14 wherein said gain medium is consisting of Yb³⁺:YAG optical material

16. The laser of claim 1 wherein said saturable absorber comprises a solid-state material.

17. The laser of claim 16 wherein said saturable absorber is selected from the group consisting of Cr³⁺:YAG, LiF:F₂

18. The laser of claim 1 wherein said mirrors are flat, convex-plano, or convex-convex.

19. A passively Q-switched laser based on Yb:YAG as the gain medium comprising:
a) a resonant cavity formed between a first mirror and a second mirror;
b) a gain medium disposed within said resonant cavity for producing laser gain;
c) a laser-diode pump source for energizing said gain medium; and
d) a saturable absorber disposed within said resonant cavity; said saturable absorber, said second mirror, and said laser gain being selected so that output pulses having a power greater than about 100 kilowatts are generated.
e) two undoped pieces disposed within the resonator cavity, diffusion bonded to the said saturable absorber and gain medium. The said first and second mirror are the dielectric coatings disposed on the undoped pieces outer surfaces

20. The laser of claim 19 wherein said second mirror 20 is of reflectivity R, where R is chosen in to be approximately less or equal to the unbleached transmission of saturable absorber

21. A passively Q-switched laser comprising:
a) a resonant cavity formed between a first mirror and a second mirror;
b) a gain medium disposed within said resonant cavity for producing laser gain;
e) a laser-diode pump source for energizing said gain medium; and
d) a saturable absorber disposed within said resonant cavity; said saturable absorber, said second mirror, and said laser gain being selected so that output pulses having a peak power greater than about 100,000 times said laser-diode pump power are generated.

22. The laser of claim 21 wherein said second mirror is of reflectivity R, where R≦T_{sa,closed}, and T_{sa,closed} is the initial, unbleached transmission of said saturable absorber to the microlaser radiation light.
